(19) United States
(12) Patent Application Publication
(10) Pub. No.: US 2025/0365104 A1
(43) Pub. Date: Nov. 27, 2025

(54) METHODS FOR REDUCTION OF PEAK SIGNAL POWER OF ORTHOGONAL FREQUENCY DIVISION MULTIPLEXING (OFDM) SIGNALS USING PARTIAL TRANSMISSION SEQUENCES (PTS)

(71) Applicant: Vecima Networks Inc., Victoria (CA)

(72) Inventors: Khai The NGUYEN, Saskatoon (CA); Ebrahim E. Bedeer MOHAMED, Saskatoon (CA); Colin Andrew HOWLETT, Saskatoon (CA)

(21) Appl. No.: 19/217,190

(22) Filed: May 23, 2025

Related U.S. Application Data
(60) Provisional application No. 63/651,312, filed on May 23, 2024.

(51) Int. Cl. H04L 5/00; H04W 52/02

(52) U.S. Cl. CPC H04L 5/0007; H04W 52/0235

(57) ABSTRACT

A method for reducing peak-to-average signal power in a transmitted orthogonal frequency division multiplexing (OFDM) signal is described.

### TECHNICAL FIELD

The following relates generally to an algorithm that can be applied to orthogonal frequency division multiplexing (OFDM) signals to reduce the peak signal power, which allows the linear amplifier to work at a higher efficiency. A key technique of this invention is partial transmission sequences (PTS).

### BACKGROUND

The rate at which digital data can be reliably transported over a communications link is determined by several factors. Among the most influential are the bandwidth of the link, the modulation scheme, the error correction coding scheme and the ratio of average signal power to average noise power at the receiver.

The average signal power entering the communications link at the transmitter is limited by the peak signal power that the linear amplifier can deliver, without distortion, to the link. The maximum average signal power that can be delivered to the receiver for a given linear power amplifier is the product of: (the peak power the linear amplifier can deliver) multiplied by (the ratio of average signal power to peak signal power) multiplied by (the losses in the link).

Communication systems based on OFDM are sensitive to distortion caused by the power amplification stage at the transmitter. This is due to the nature of OFDM signal, which has a high peak-to-average power ratio (PAPR). An OFDM signal transmitted through a power amplifier will be distorted if its amplitude exceeds a threshold value, which is a parameter of the power amplifier and depends on the amplifier's design.

It would therefore be desirable to minimize the adverse effects of signal distortion introduced by the power amplifier to the communication system. One way to do this would be to reduce the PAPR, or more precisely, the peak power of OFDM signals.

The problem to be solved by the present invention is the undesirably low ratio of average power to peak power in OFDM signals. Equivalently, the problem is the undesirably high peak-to-average-power ratio of OFDM signals.

### SUMMARY OF THE INVENTION

In one broad aspect of the invention, there is provided a method for reducing peak-to-average signal power in a transmitted OFDM signal comprising: manipulating the OFDM signal before transmitting over a channel by decomposing the original OFDM signal into the sum of multiple component sub-signals; optimized processing of each component sub-signal in the form of a phase rotation; manipulating a reference sub-signal by adding cancelling signals to further reduce peak power of the OFDM signal; and combining the component sub-signals together to achieve an alternated OFDM signal with a lower peak power as compared to the original OFDM signal.

### BRIEF DESCRIPTION OF THE DRAWINGS

Embodiments will now be described by way of example only with reference to the appended drawings wherein:

FIG. 1 shows a block diagram of the transmitter and receiver of a conventional OFDM system with PTS scheme (PRIOR ART);

FIG. 2 shows a block diagram of the transmitter and receiver of the PTS-OFDM system of the invention;

FIG. 3 shows a representation of PAM constellations under the effect of canceling signal;

FIG. 4 shows a graphical representation showing probability mass function of λ;

FIG. 5 shows a block diagram of the CS approx. and FEC block at transmitter; and

FIG. 6 shows a block diagram of the CS recover block at the receiver.

### DETAILED DESCRIPTION OF THE INVENTION

The invention reduces the signal distortion in communication systems based on OFDM that are introduced by high power amplifiers by reducing the peak power of the transmitted OFDM signals. This is done by manipulating the OFDM signal before transmitting over the channel, such that the obtained new signal has a lower peak power as compared to the original one, yet still ensures the signal recovery capability at the receiver.

Specifically, the original signal is decomposed into the sum of multiple component sub-signals. Each component sub-signal then goes through optimized processing, which is in the form of a phase rotation, before being combined together again to achieve an alternated signal with a lower peak power as compared to the original one. This method is called partial transmission sequence (PTS) in literature.

Many research works have been done to optimize this method to better reduce the OFDM signal's peak power. See References [1]-[10].

The novelty of the design described herein lies in the signal processing for the “reference” component sub-signal. In existing designs, this “reference” component sub-signal acts as a phase reference for others, and hence, is left untouched throughout the PTS scheme. Differently, in the design of the present invention, the reference sub-signal may be manipulated by adding canceling signals (canceling means reducing the peak) to further reduce the peak power of the OFDM signal. With this extra signal processing on the reference sub-signal, the peak power can be significantly further reduced as compared to existing designs, which left the reference sub-signal untouched.

The reason existing works do not consider this approach to reduce the peak power of OFDM signal may be due to the fact that other works need this first sub-signal without phase rotation to be a reference point to help the receiver to identify the phase on other sub-signals. As a result, the first sub-signal is usually left untouched. In addition, adding canceling signals to the first sub-signal means adding more noise to the data bearing signal, which severely degrades the communication quality.

This proposed design overcomes this obstacle by a novel approach to optimize the cancelling signals and a coding mechanism such that not only can it reduce the OFDM signal's peak power, but it is also recognizable at the receiver, which ensures the reliability of data detection. The canceling signals are designed to be recognizable (and hence, removable) by the receiver. However, in the presence of noise, the reliability of canceling signal recognition at the receiver is reduced. To tackle this problem, a novel coding mechanism is developed. The coding mechanism encodes the binary representation of the signs of the canceling signals (0 for (−), 1 for (+)) with a systematic code and embeds the resulted parity bits on the canceling signals themself. As a result, no overhead is required to carry the parity bits arising from canceling signals' sign encoding. The coding mechanism increases the reliability of the canceling signal recognition at the receiver significantly. It may be emphasized that the coding mechanism developed in this work encodes the sign information of the canceling signals only, and is different from channel coding (for input binary data). In addition, the coding mechanism does not affect the implementation of channel coding (on the input binary data).

Existing designs of PTS schemes to reduce the PAPR of OFDM signals mostly focus on the optimization of the phase factors, which cannot exploit the degrees of freedom from the “reference” component signal. The difference in the proposed design as compared to known methods is the usage and optimization of a cancelling signal, which is added to the “reference” component signal of the PTS scheme. This novel idea can significantly reduce the peak power of the OFDM signal as compared to the existing PTS scheme where the reference component signal is left unchanged. Advantages of the present invention include significantly lower Bit-Error-Rate (BER) and PAPR as compared to existing PTS designs.

Please see simulation results in Graphs 1 to 5 below evidencing the merits of the proposed PTS scheme.

The simulation results illustrate the performance gain of the proposed PTS method, in comparison with original OFDM (no PAPR reduction), conventional PTS (C-PTS), and the blind PTS schemes in Reference [10], which reports one of the best performances to date. The PAPR reduction performance is evaluated by the complementary cumulative density function (CCDF), which is defined as:

$$CCDF = Pr ( PAPR \geq {PAPR}_{0} )$$

For the conventional PTS (C-PTS) scheme, an exhaustive search is performed on the set of four phases. For the proposed scheme of the present invention, quantized phase factors from Reference [10] were used to avoid using side information (SI), which is a message from the transmitter to the receiver to acknowledge the receiver on how the signals are manipulated at the transmitter (with phase factor rotation, added canceling signals to reduce the PAPR). For the sign-protection, the DVB-S2 low-density-parity-check (LDPC) code with rate R=3/4 and codeword length of 64800 bits is used.

Graphs 1-4 above demonstrate the PAPR reduction performance of the proposed PTS scheme in comparison with the aforementioned methods. Following the optimization steps in Section II, the chosen values of λ for 64-QAM constellation λ=3.5 and for 256-QAM is λ=7.5. As can be seen in Graphs 1-2, with N=256 subcarriers, the method of the present invention is about 1.5 dB better than conventional PTS and 1 dB better than the scheme in Reference [10]. With N=512 subcarriers, the gap widens to 2 dB and 1.5 dB over conventional PTS and the schemes in [10], respectively.

Graph 5 shows the symbol error rate (SER) of different PTS schemes under the effect of a solid state power amplifier (SSPA) with the instantaneous input-output amplitude relation Reference [11]:

$${A}_{o u t} = \frac{{A}_{i n}}{{[ 1 + {( \frac{{A}_{i n}}{{A}_{sat}} )}^{2 ρ} ]}^{\frac{1}{2 ρ}}}$$

where Aᵢₙ and Aₒᵤₜ are the instantaneous input and output amplitudes, respectively, ρ is the smoothness parameter, and Aₛₐₜ is the saturation (limit) amplitude. Here, these may be set as ρ=3 and Aₛₐₜ=2σₓ, where

$${σ}_{x} = \sqrt{E \{ {\vert x [ n ] \vert}^{2} \}}$$

is the standard deviation of the OFDM time domain signal. Thanks to a significantly better PAPR, the proposed method of the present invention outperforms original PTS with no PAPR reduction and is about 3.5 dB better than the blind PTS scheme in Reference [10] at the SER of 10⁻⁴. The gap gets much wider at higher SNRs (and lower SER), where original OFDM is likely to reach an error floor. This is due to the fact that at higher SNR, the non-linear distortion becomes the dominant source of noise, and hence, increasing the SNR does not help improve the SER. Whereas, the proposed scheme of the present invention can still achieve a performance which is very close to that one of the ideal OFDM system with no high power amplifer (HPA) effect.

In Graph 5, the effect of the canceling signal (CS) sign protection using the novel coding mechanism is shown. According to the graph, with no sign protection, the proposed PTS method's performance is eventually worse than that of the blind PTS scheme in Reference [10]. The reason is that the error in detecting the sign information S^{(real)} and S^{(imag)} leads to a false CS reconstruction, and hence, the receiver ends up adding more noise rather that subtracting it. As a consequence, the SER is severely degraded. Meanwhile, with sign-protection by coding, a gain of around 5.5 dB can be achieved at the SER of 10⁻⁴ over the no-sign protection case. The performance of the proposed method with sign-protection is identical to that of known-SI case for SNR values greater than 25 dB. It can also be noticed that there is a sharp drop in the SER from the SNR of 24 to 25 dB. The reason is that below 24 dB, the sign-protection is still erroneous, which leads to a huge gap between the performance of the known-SI and the case of sign-protection. Whereas, for higher SNR values, the coding successfully protects the sign information S^{(real)} and S^{(imag)} from errors. As a result, the performance of the proposed design is almost identical to the known-SI case.

In addition, a novel coding mechanism to encode the information about the added canceling signal is designed to assist the receiver to remove the canceling signal before data demodulation. This ensures that the additional canceling signal to reduce the peak power of the OFDM signal does not affect the reliability of data detection.

It is of note that in the majority of existing PTS designs in literature, the so-called “side information” (SI), which is a message from the transmitter to the receiver, is required to inform the receiver about what values of phase factors have been used at the transmitter to rotate the sub-signals. In the proposed design, the receiver can perform blind estimation of the phase factors as well as the canceling signals with high reliability. This can be done using the method in Reference [10] without the need to transmit SI. Thus, no data rate overhead associated with the SI transmission is required in this design. The phase factors blind estimator is adopted from Reference [10].

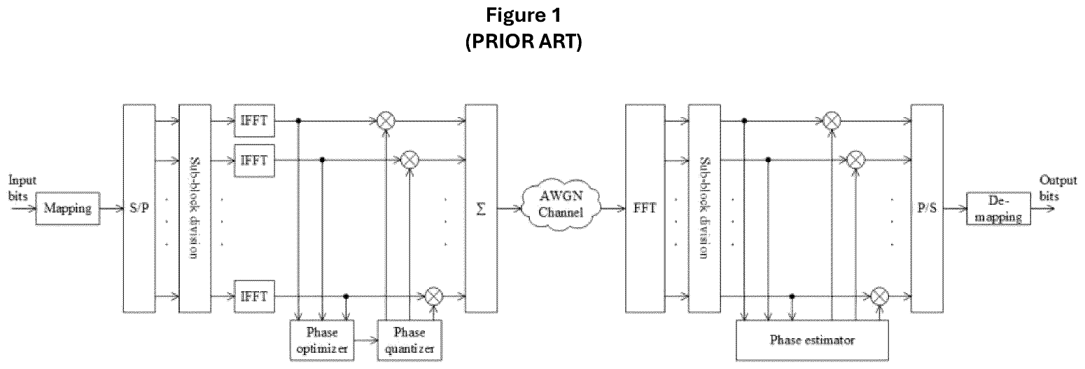

It is helpful to review the existing PTS schemes to aid in showing the innovation in the invention described herein. The top-level block diagram of an OFDM system with conventional PTS is shown in FIG. 1.

Similar to a conventional OFDM system, the input to the PTS-OFDM system is a stream of input bits (which can be either uncoded or coded with channel coding), which is then mapped to QAM symbols with QAM modulation. The difference starts at the “Subblock division” block. This block separates the N QAM symbols on N frequencies into G sub-blocks (SBs). Each SB consists of N_{G} frequencies. Each SB is then processed with N-IFFT (Inverse Fast Fourier Transform) separately, which results in G N-sample time-domain signal sequences. These G time-domain sequences are the “component signal” referred to above. Thanks to the linearity of the IFFT, one can directly add up these G N-sample sequences to obtain the time-domain OFDM signal sequence to be transmitted to the channel as in conventional OFDM system. However, due to the nature of OFDM, the resulted time-domain signal sequence (or in other words, the original OFDM signal sequence without PTS scheme), has a very high PAPR.

To alleviate the PAPR issue with PTS scheme, rather than directly adding up the G sequences from G SBs, one can perform a weighted summation instead. The weights applied before summation on each SBs' sequences must satisfy the following rules:
RULE 1: The weight vector must be of unit power, which means it can only be a phase rotation.
RULE 2: The PAPR of the signal after the summation with this weight must be lower than the original OFDM signal.

The weights just apply phase rotations to the respective sequences before summation. Hence, the problem of finding the optimal weights is equivalent to finding the phase of the weights. These phases are commonly referred to as phase factor in PTS literature.

The optimization of the phase factor is performed in the “phase optimizer” block. The input to this block is the G N-sample sequences from the G SBs. There are many approaches in the literature to find the optimal phase factor, e.g., performing an exhaustive search on a predetermined limited set of phase values, utilizing machine learning, or using convex optimization.

The phase quantizer block is unique to the phase optimization scheme in Reference [10]. This block does not exist in other designs in literature. The reason the phase quantizer block and the optimization scheme in Reference [10] is deployed in this design is for the completeness of the presentation. Although this design focuses on the first sub-signal of the first SB, and the problem of estimating/detecting the phase factors of other SBs can be separated into an independent problem, this phase quantizer block will help the receiver to estimate the phase vector without requiring the transmitter to transmit any additional information. With this, the entire system in this design does not require SI. Otherwise, if any other PTS scheme is used, which requires SI to acknowledge the receiver about the phase factors, it would be counterintuitive to have the estimation/detection of the canceling signal in the first SB's sub-signal to be blind (i.e. does not require SI).

After the optimal phase factors for all SBs have been found, the weighted summation is performed on G sequences of G SBs to obtain an alternated OFDM time-domain sequence signal, which has a lower PAPR than the original one. This alternated sequence will then be transmitted via the channel to the receiver.

At the receiver, the reverse process is performed. After performing the FFT (Fast Fourier Transform) on the received time-domain signal sequence to obtain the frequency-domain samples on N frequencies, the obtained N samples are sorted into their G SBs. Then, the samples on each SB are rotated back by the same phase factor applied at the transmitter. In order to do this, the receiver must be aware of the applied phase factors at the transmitter. This can be done by transmitting the SI, which contains the information of the applied phase factors by the transmitter. The drawback of this approach is the data rate overhead associating with the SI transmission. Another approach is implementing blind-PTS schemes where the phase factors can be reliably estimated by the receiver without SI Reference [10] which is achieved with the help of the phase quantizer at the transmitter.

The existing approaches have one thing in common, which is the first SB, or the “reference” SB (or reference component signal mentioned in previous questions). Since PTS scheme only applies phase rotation to every SB, it is convenient, and simple, to set the phase factor of the first SB to “0”, which means this SB acts as a phase reference, and hence, its sequence remains unchanged.

This might be a missing opportunity to further reduce the PAPR of the OFDM signal since the degrees of freedom of the signal on this first SB is not utilized.

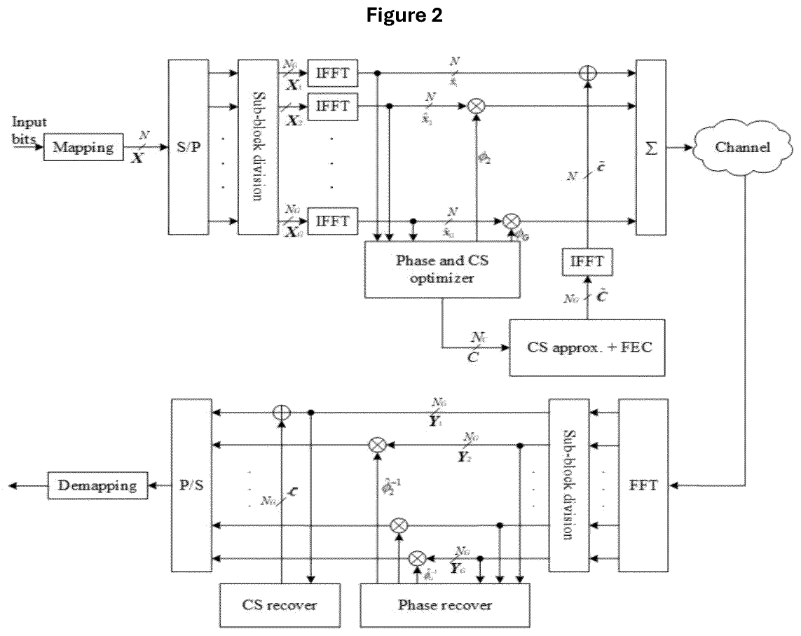

In order to take advantage of the above, in the design of the present invention, there is a significant design difference, as may be noted with reference to FIG. 2.

A significant design difference of the PTS-OFDM system of the present invention, when compared to the conventional PTS-OFDM system, is a novel mechanism that adds “canceling signal” (CS) to the first SB to further reduce the PAPR. With reference to labels provided in FIG. 2, this includes the novel “Phase and CS optimizer” block and “CS approx.+FEC” block at the transmitter side, and the “CS recover” block at the receiver side.

The operation of the transmitter in this novel design is the same as the existing PTS designs in terms of the weighted summation on the G signal sequences from G SBs. Thus, from the input bits mapping to the SB division and G independent IFFT blocks, the proposed design is the same as existing PTS designs. However, unlike existing designs where the first SB is left unchanged, the proposed design adds CSs to the first SB to further reduce the PAPR.

The CSs are optimized together with the phase factor in the novel “Phase and CS optimizer” block, which is a modification to the “phase optimizer” block from the existing designs in Reference [10]. The inputs to this block are the G partial sequences of G SBs. With this information, the CS optimizer block performs optimization to find (G−1) optimal phase factors (for (G−1) SBs, except the first SB) and a complex-valued signal vector C initially of length NG, (in FIG. 2, the length of C is shown as N_{C}, not N_{G}, (N_{C}<N_{G}). This is then added to the N_{G} QAM signal samples of the first SB to further reduce the PAPR. Two criteria to optimize the CS:
The CS is optimized to reduce the PAPR of the OFDM signal.
The CS is optimized such that the signal of the first SB can still be reliably detected at the receiver without SI.

The first criterion is not hard to achieve. By solving a convex optimization problem, a vector of NG optimal complex samples can be obtained to be added to the first SB to reduce the PAPR as much as possible. However, the signals obtained by solving this convex optimization problem can take on any complex values, which is unknown by the receiver. As a consequence, adding them to the signals of the first SB means adding more noise, which degrades the receiver performance significantly.

Again, it is worth noting that this CS can only be added to the first sub-signal of the first SB, not to other SBs. The reason is that unlike the first SB, which is not rotated by a phase factor, the unknown phase rotation in other SBs make it impossible for the receiver to recover the CSs of these SBs before demodulation. In addition, the presence of the added CSs also makes it impossible for the blind estimator in Reference [10] to detect the phase factors in the first place. Thus, even though it is technically possible to optimize and add CSs into other SBs (instead of just only the first SB) to further reduce the PAPR, it is almost impossible to recover (and then, remove) both the CSs and the phase factors for these SBs.

Therefore, rather than adding C directly to the first SB, an alternative canceling signal \tilde{C} that is partially known by the receiver is used, which helps with the detection. The idea is that, instead of adding the exact optimal CS value C, an alternate CS \tilde{C} is just added that follows opposite direction of the gradient of the OFDM signal's PAPR. Thus, this alternative canceling signal has the same signs as the optimal canceling signal C to follow a somewhat close direction with the optimal canceling signal C to the lowest PAPR), but with a known absolute value of λ (λ>0) on both the real and the imaginary parts. This value of λ is known by the receiver. Mathematically, this alternative CS C has the form of:

$$\tilde{C} = λ ( {S}^{( real )} + {jS}^{( imag )} )$$

Where S^{(real)} and S^{(imag)} are the vectors containing the sign information of the real and imaginary parts of the optimal CS C, whose elements are of either −1 or 1.

The value of λ must be chosen to:
Make the added CSs recognizable at the receiver.
Minimize the loss of PAPR reduction performance as compared to using C.

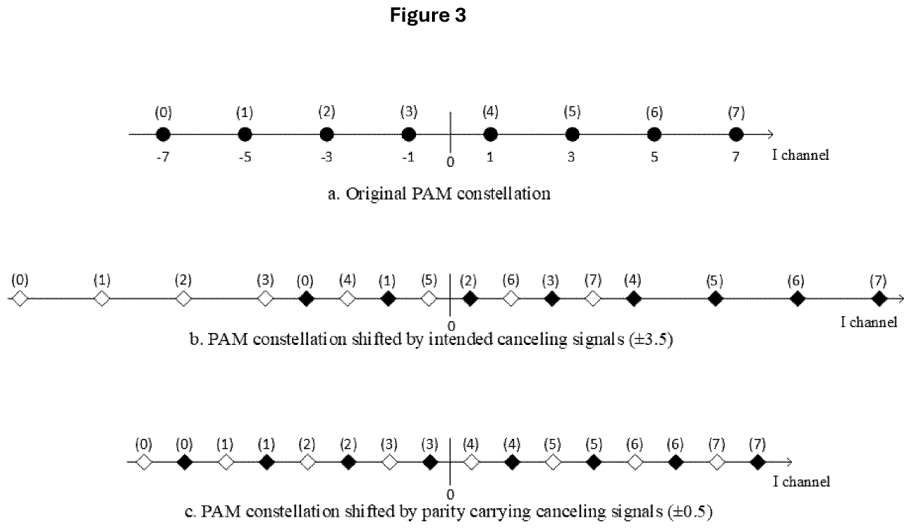

To satisfy the first criterion above, the value of A must be in the form of:

$$λ = ( \frac{i}{2} + \frac{1}{4} ) Δ , i ∈ Z$$

where Δ is the minimum Euclidean distance between two points on the QAM constellation and Z is the set of integer numbers. For example, if Δ=2, λ can take on the value of 0.5, 1.5, 2.5, 3.5, etc. FIG. 3 illustrates the effect of adding the canceling signal to the real (or imaginary) part of a QAM symbol. As can be seen, the QAM symbols added with −λ (white stars) or λ (black stars) can still be distinguished.

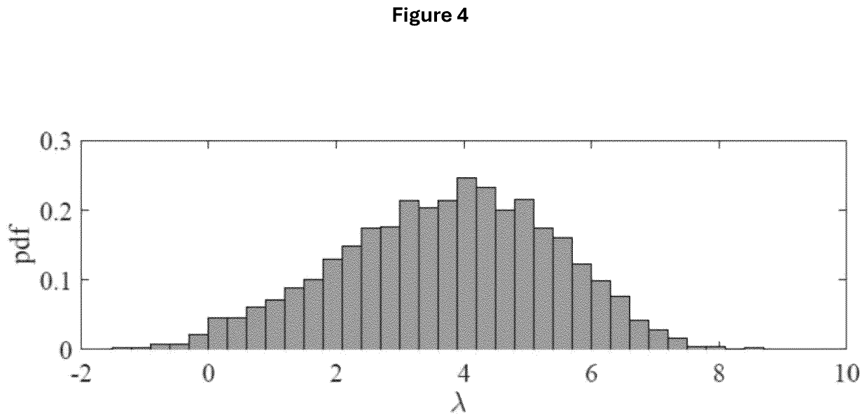

To satisfy the second criterion, the distribution of the optimal C is taken into account, as can be seen in FIG. 4. In FIG. 4, the optimal value of λ is obtained for the case of 64-QAM constellation. A value of λ that is close to the mean of the distribution should be chosen while satisfying the previous criterion. As can be seen, the value of λ should be in the range from 3.5-4.5. With the first criterion above, the value λ=3.5 can be chosen. By choosing a highly probable value of λ according to the pdf, the loss in PAPR reduction performance when approximating C to \tilde{C} is reduced to some extent.

As can be seen from FIG. 3b, in an ideal case of noise-free communication, the receiver can easily recognize whether −λ or λ has been added to the QAM symbols (since the white stars and the black stars are non-overlapped), and hence, can remove them before demodulation.

Although with the first criterion of the CS, it is possible to recognize whether −λ or λ has been added to a QAM symbol, the recognition reliability is low in the presence of noise. The reason is, as illustrated in FIG. 3, is the small Euclidean distance (Δ/2) between the signal of the two cases (−λ—white stars and λ—black stars). Thus, a coding mechanism is developed to increase the reliability of recovering the CS \tilde{C} at the receiver. Specifically, this coding mechanism is to encode the sign information (the signs of the real and the imaginary parts) of the alternative CS C (not the data bits).

Rather than optimizing the CS on all N_{G} frequencies of the first SB, the “phase factor and CS optimizer” block only considers the first N_{C} frequencies of the first SB to optimize the CSs and leave the remaining N_{P}=N_{G}−N_{C} frequencies unchanged. Hence, the output of the “phase factor and CS optimizer” block are now the (G−1) phase factors, and a CS signal vector of length N_{C} (instead of N_{G} as originally initially discussed above) as shown in FIG. 2.

Then, the output CS vector of length N_{C} enters the “CS approx. and FEC” block, and is also rounded up into either ±λ using the above criteria. The mechanism for this round-up step is shown in FIG. 4. First, the CSs of length N_{C} output from the “phase factor and CS optimizer” block is separated into the real and imaginary parts. Then, the signs of each part is taken separately, resulting in 2N_{C} sign bits, naming b^{(real)} and b^{(imag)}, each of length N_{C}. These binary sign bits then enter the circuit on top of FIG. 4 to generate the alternative rounded-up CS of length N_{C} that follows the two criteria of the CS. These binary sign vectors are related to the sign information vectors (of value±1) by:

$${S}_{i}^{( real )} = 2 {b}_{i}^{( real )} - 1 , i = 1 , 2 … {N}_{c}$$

For the FEC, the 2N_{C} sign bits b^{(real)} and b^{(imag)} also enter the FEC block, which implements a systematic channel code of rate R=N_{C}/N_{G} to generate 2N_{P} parity bits (N_{P}=N_{G}-N_{C}), naming p^{(real)} and P^{(imag)}.

These 2N_{P} parity bits p^{(real)} and p^{(imag)} are then modulated on the remaining Np frequencies of the first SB, which are reserved and remain unchanged until now. This is done by generating N_{P} complex-valued signals, using the first criterion of the CSs on the first N_{C} frequency to be added into the QAM symbols carried on the N_{P} reserved frequencies of the first SB. Specifically:
If

$${p}_{i}^{( real )} = 0 ,$$

add (−χ) to the real part of the QAM symbol on that frequency, if

$${p}_{i}^{( real )} = 1 ,$$

add (+χ).
Similar for

$${p}_{i}^{( imag )}$$

and the imaginary part of that QAM symbol.

To make it possible for the receiver to recognize if (−χ) or (+χ) has been added to a QAM symbol, χ must also satisfies the first criterion for A mentioned above, which is: χ must take on the value of 0.5, 1.5, 2.5, 3.5, etc. (for λ=2). In addition, since at first, the Np parity bearing frequencies are not intended to add any CS, the value of χ should be minimal (close to 0 as much as possible) to minimize the PAPR degradation. Hence, χ=0.5 is chosen.

The resulting QAM symbols added with the above parity bearing signal are shown in FIG. 3c, where the white stars is the QAM symbols when

$${p}_{i}^{( real )} = 0 ( - 0.5 added )$$

and the black stars are when

$${p}_{i}^{( real )} = 0 ( - 0.5 added ) .$$

Thus, based on the received signals, the receiver can decide if the parity bits

$${p}_{i}^{( real )}$$

is 0 (if received signal point is closer to the white stars), or

$${p}_{i}^{( real )}$$

is 1 (if received signal point is closer to the black stars).

For the first SB, the key step is to recover the sign information of the CS as well as the parity. From that, the added CSs can be recovered, and subtracted from the first SB's signal. To do this, the log-likelihood ratios (LLRs) of the sign information bits and the parity bits have to be calculated.

As can be seen from FIG. 2, the received signals from the channel, after processed with FFT, is then separated into their SBs. For every SB except for the first one, the phase recover can be done according to the phase factor optimization method deployed at the transmitter. In this design, the convex optimization method and phase quantization in Reference is utilized to find the optimal phase factors. Hence, the blind phase estimator in Reference is used to recover the phase factors at the receiver.

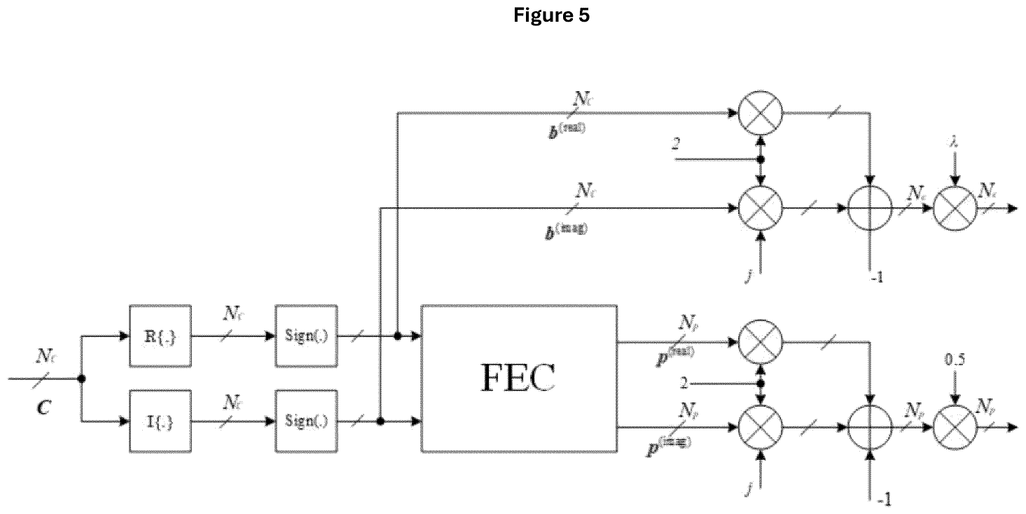

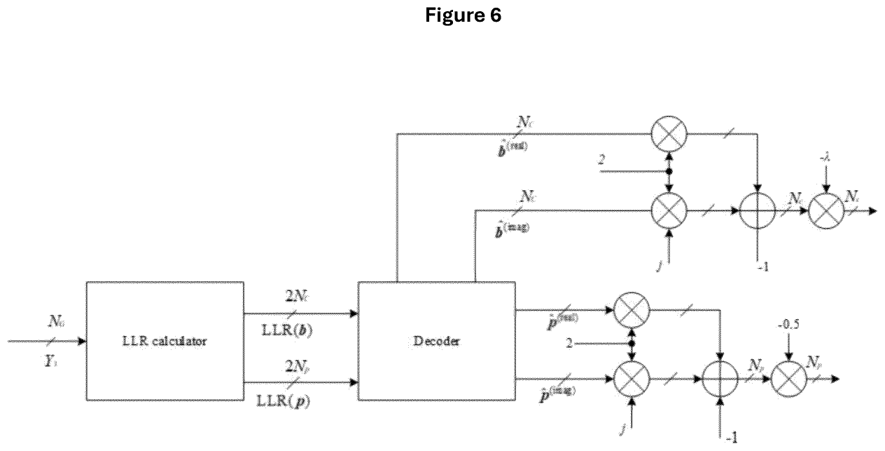

For the first SB, which is not affected by any phase rotation, but the CSs, the first SB's signals enter the “CS recover” block. Inside this block, which is shown in FIG. 6, first, the signals of the first SB Y₁ of length N_{G} enter the “LLR calculator” block. Then, based on the received signal Y₁, this block calculates the LLR of the 2N_{C} sign bits of the CS C and the LLR of the 2N_{P} parity bits (the algorithm to calculate the LLR is well-known). These total 2N_{C}+2N_{P}=2N_{G} LLRs, output from the “LLR calculator” block, then enters the “decoder” block, which performs soft-input-soft-output decoding, to obtain the final decision of the CS's sign information. With the final decision on the sign bits and the parity bits output from the “decoder” block, the CSs on the first N_{C} subcarriers are recovered using the mechanism on the top of the “decoder” block as shown in FIG. 6. Whereas, the CSs on the last N_{P} subcarriers (parity carriage subcarriers) are recovered by the mechanism to the right of the decoder. It can be seen that these two circuits are exactly the same as the CSs generating mechanism in the transmitter in FIG. 5.

After that, the CSs added to the first SB are recovered, and subtracted from the received signal. Then, the QAM modulation is performed to retrieve the binary data.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples used herein are for illustrative purposes only. Different terminology can be used without departing from the principles expressed herein.

Although the above principles have been described with reference to certain specific examples, various modifications thereof will be apparent to those skilled in the art as outlined in the appended claims.

### REFERENCES

[1] L.˜J. Cimini and N.˜R. Sollenberger, “Peak-to-average power ratio reduction of an OFDM signal using partial transmit sequences,” IEEE Commun.Lett., vol.˜4, no.˜3, pp. 86--88, Mar. 2000.
[2] A.˜Alavi, C.˜Tellambura, and I.˜Fair, “PAPR reduction of OFDM signals using partial transmit sequence: an optimal approach using sphere decoding,” IEEE Commun. Lett., vol.˜9, no.˜11, pp. 982--984, Nov. 2005.
[3] T.˜T. Nguyen and L.˜Lampe, “On partial transmit sequences for PAR reduction in OFDM systems,” IEEE Trans. Wireless Commun., vol.˜7, no.˜2, pp. 746--755, Feb. 2008.
[4] J.˜Zhou, E.˜Dutkiewicz, R.˜P. Liu, X.˜Huang, G.˜Fang, and Y.˜Liu, “A modified shuffled frog leaping algorithm for {PAPR} reduction in OFDM systems,” IEEE Trans. Broadcast., vol.˜61, no.˜4, pp. 698--709, Dec. 2015.
[5] Y.-J. Cho, J.-S. No, and D.-J. Shin, “A new low-complexity PTS scheme based on successive local search using sequences,” IEEE Commun. Lett., vol.˜16, no.˜9, pp. 1470--1473 Sep. 2012.
[6] S.-J. Ku, C.-L. Wang, and C.-H. Chen, “A reduced-complexity PTS-based PAPR reduction scheme for {OFDM} systems,” IEEE Trans. Wireless Commun., vol.˜9, no.˜8, pp. 2455--2460 Aug. 2010.
[7] D.-W. Lim, S.-J. Heo, J.-S. No, and H.˜Chung, “A new PTS OFDM scheme with low complexity for PAPR reduction,” IEEE Trans. Broadcast., vol.˜52, no.˜1, pp. 77--82, Mar. 2006.
[8] Y.-J. Cho, K.-H. Kim, J.-Y. Woo, K.-S. Lee, J.-S. No, and D.-J. Shin, “Low-complexity PTS schemes using dominant time-domain samples in OFDM systems,” IEEE Trans. Broadcast., vol.˜63, no.˜2, pp. 440--445, Jun. 2017.
[9] K.-S. Lee, H.˜Kang, and J.-S. No, “New PTS schemes with adaptive selection methods of dominant time-domain samples in OFDM systems,” IEEE Trans. Broadcast., vol.˜64, no.˜3, pp. 747--761, Sep. 2018.
[10] T.˜K. Nguyen, H.˜H. Nguyen, J.˜E. Salt, and C.˜Howlett, “Optimization of partial transmit sequences for PAPR reduction of OFDM signals without side information,” IEEE Trans. Broadcast., vol.˜69, no.˜1, pp.313--321, 2023.

[11] C.˜ Rapp, “Effects of HPA-nonlinearity on 4-DPSK/OFDM signal for a digital sound broadcasting system,” in Proc. European Conference on Satellite Communication, 1991, pp. 179--184.

1. A method for reducing peak-to-average signal power in a transmitted orthogonal frequency division multiplexing (OFDM) signal comprising:
manipulating the OFDM signal before transmitting over a channel by decomposing the original OFDM signal into the sum of multiple component sub-signals;
optimized processing of each component sub-signal in the form of a phase rotation;
manipulating a reference sub-signal by adding cancelling signals to further reduce peak power of the OFDM signal; and
combining the component sub-signals together to achieve an alternated OFDM signal with a lower peak power as compared to the original OFDM signal.

2. A method for recognizing the cancelling signals, without requiring any side information, comprising:
encoding the sign information of the canceling signals with a coding mechanism at the transmitter to improve reliability of cancelling signals recognition in the presence of noise;
manipulating the cancelling signals to also carry the coding redundancy; and
reconstructing the cancelling signals with a decoding mechanism at the receiver by decoding the sign information of the cancelling signals.
